(19) United States
(12) Patent Application Publication
(10) Pub. No.: US 2025/0037022 A1
(43) Pub. Date: Jan. 30, 2025

(54) APPARATUS, METHOD AND COMPUTER PROGRAM

(71) Applicant: Nokia Technologies Oy, Espoo (FI)

(72) Inventors: Chaitanya AGGARWAL, Munich (DE); Saurabh Khare, Bangalore (IN); Divya G Nair, Bangalore (IN); Tejas Subramanya, Munich (DE)

(21) Appl. No.: 18/758,848

(22) Filed: Jun. 28, 2024

(30) Foreign Application Priority Data
Jul. 28, 2023 (IN) 202311051051

(51) Int. Cl. G06N 20/00

(52) U.S. Cl. CPC G06N 20/00

(57) ABSTRACT

There is provided an apparatus comprising means for: receiving a request from an analytics consumer for analytics information from a first machine learning model, obtaining the first machine learning model, obtaining a second machine learning model, the second machine learning model being trained prior to the first machine learning model, the first machine learning model and the second machine learning model having the same analytics identifier; obtaining a first inference output from the first machine learning model and a second inference output from the second machine learning model, determining, based on the first inference output and the second inference output that the first machine learning model has been attacked and providing an indication to a network entity that the first machine learning model has been attacked.

### FIELD

The present application relates to a method, apparatus, system and computer program and in particular but not exclusively to the detection and mitigation of data poisoning attacks.

### BACKGROUND

A communication system can be seen as a facility that enables communication sessions between two or more entities such as user terminals, base stations and/or other nodes by providing carriers between the various entities involved in the communications path. A communication system can be provided for example by means of a communication network and one or more compatible communication devices. The communication sessions may comprise, for example, communication of data for carrying communications such as voice, video, electronic mail (email), text message, multimedia and/or content data and so on. Non-limiting examples of services provided comprise two-way or multi-way calls, data communication or multimedia services and access to a data network system, such as the Internet.

In a wireless communication system at least a part of a communication session between at least two stations occurs over a wireless link. Examples of wireless systems comprise public land mobile networks (PLMN), satellite based communication systems and different wireless local networks, for example wireless local area networks (WLAN). Some wireless systems can be divided into cells, and are therefore often referred to as cellular systems.

A user can access the communication system by means of an appropriate communication device or terminal. A communication device of a user may be referred to as user equipment (UE) or user device. A communication device is provided with an appropriate signal receiving and transmitting apparatus for enabling communications, for example enabling access to a communication network or communications directly with other users. The communication device may access a carrier provided by a station, for example a base station of a cell, and transmit and/or receive communications on the carrier.

The communication system and associated devices typically operate in accordance with a given standard or specification which sets out what the various entities associated with the system are permitted to do and how that should be achieved. Communication protocols and/or parameters which shall be used for the connection are also typically defined. One example of a communications system is Universal Mobile Telecommunications System (UMTS) Terrestrial Radio Access Network (UTRAN) (3G radio). Other examples of communication systems are the long-term evolution (LTE) of the Universal Mobile Telecommunications System (UMTS) radio-access technology and so-called 5G or New Radio (NR) networks. NR is being standardized by the 3rd Generation Partnership Project (3GPP). Other examples of communication systems include 5G-Advanced (NR Rel-18 and beyond) and 6G.

### SUMMARY

In a first aspect there is provided an apparatus comprising means for receiving a request from an analytics consumer for analytics information from a first machine learning model, obtaining the first machine learning model, obtaining a second machine learning model, the second machine learning model being trained prior to the first machine learning model, the first machine learning model and the second machine learning model having the same analytics identifier, obtaining a first inference output from the first machine learning model and a second inference output from the second machine learning model, determining, based on the first inference output and the second inference output that the first machine learning model has been attacked and providing an indication to a network entity that the first machine learning model has been attacked.

The apparatus may comprise means for determining a concept drift between the first inference output and the second inference output and determining that the first machine learning model has been attacked based on the determined concept drift.

The apparatus may comprise means for determining that the first machine learning model has been attacked based on a concept drift threshold value.

The apparatus may comprise means for providing the first inference output to the analytics consumer, obtaining feedback information based on the first inference output from the analytics consumer and determining that the first machine learning model has been attacked further based on the feedback information.

The apparatus may comprise means for obtaining first training data used for training the first machine learning model from at least one network function, obtaining second training data used for training the second machine learning model from the at least one network function and determining a network function from the at least one network function where the first machine learning model was attacked based on the first training data and the second training data.

The apparatus may comprise means for determining a data distribution drift based on the first training data and the second training data.

The apparatus may comprise means for determining the network function from the plurality of network functions based on a data distribution drift threshold value.

The apparatus may comprise means for providing an indication of the determined network function to the network entity.

The apparatus may comprise means for excluding the determined network function when requesting data for subsequent training of the first machine learning model.

The network entity may comprise a network analytics function, an operations and management function or a user equipment.

In a second aspect, there is provided an apparatus comprising means for receiving a request from a network entity for a first machine learning model, providing the first machine learning model and receiving an indication from the network entity that the first machine learning model has been attacked.

The apparatus may comprise means for receiving a request from the network entity for first training data from at least one network function used for training the first machine learning model, providing the first training data to the network entity and receiving an indication from the network entity, based on the first training data, of a network function determined from the at least one network function where the first machine learning model was attacked.

The network entity may comprise an analytics network function, a radio access network node or an operations and management function.

In a third aspect there is provided an apparatus comprising means for receiving a request for receiving a request from a network entity for a machine learning model associated with an analytics identifier and providing the machine learning model associated with the analytics identifier to the network entity.

The apparatus may comprise means for receiving a request from the network entity for training data from at least one network function used for training the machine learning model associated with the analytics identifier and providing the training data to the network entity.

The apparatus may comprise an analytics data repository function or a data repository comprising the machine learning model and the training data.

The network entity may comprise an analytics network function or a radio access network node.

In a fourth aspect there is provided an apparatus comprising means for providing a request from an analytics consumer for analytics information from a first machine learning model to a network entity, the first machine learning model associated with an analytics identifier, receiving first inference output from the first machine learning model from the network entity, determining feedback information based on the first inference output and providing the feedback information to the network entity.

When the feedback information is negative, the apparatus may comprise means for providing a request to the network entity for further analytics information associated with the analytics identifier.

The network entity may comprise an analytics network function or a radio access node.

In a fifth aspect there is provided a method comprising receiving a request from an analytics consumer for analytics information from a first machine learning model, obtaining the first machine learning model, obtaining a second machine learning model, the second machine learning model being trained prior to the first machine learning model, the first machine learning model and the second machine learning model having the same analytics identifier, obtaining a first inference output from the first machine learning model and a second inference output from the second machine learning model, determining, based on the first inference output and the second inference output that the first machine learning model has been attacked and providing an indication to a network entity that the first machine learning model has been attacked.

The method may comprise determining a concept drift between the first inference output and the second inference output and determining that the first machine learning model has been attacked based on the determined concept drift.

The method may comprise determining that the first machine learning model has been attacked based on a concept drift threshold value.

The method may comprise providing the first inference output to the analytics consumer, obtaining feedback information based on the first inference output from the analytics consumer and determining that the first machine learning model has been attacked further based on the feedback information.

The method may comprise obtaining first training data used for training the first machine learning model from at least one network function, obtaining second training data used for training the second machine learning model from the at least one network function and determining a network function from the at least one network function where the first machine learning model was attacked based on the first training data and the second training data.

The method may comprise determining a data distribution drift based on the first training data and the second training data.

The method may comprise determining the network function from the plurality of network functions based on a data distribution drift threshold value.

The method may comprise providing an indication of the determined network function to the network entity.

The method may comprise excluding the determined network function when requesting data for subsequent training of the first machine learning model.

The network entity may comprise a network analytics function, an operations and management function or a user equipment.

In a sixth aspect, there is provided a method comprising receiving a request from a network entity for a first machine learning model, providing the first machine learning model and receiving an indication from the network entity that the first machine learning model has been attacked.

The method may comprise receiving a request from the network entity for first training data from at least one network function used for training the first machine learning model, providing the first training data to the network entity and receiving an indication from the network entity, based on the first training data, of a network function determined from the at least one network function where the first machine learning model was attacked.

The network entity may comprise an analytics network function, a radio access network node or an operations and management function.

In a seventh aspect there is provided a method comprising receiving a request for receiving a request from a network entity for a machine learning model associated with an analytics identifier and providing the machine learning model associated with the analytics identifier to the network entity.

The method may comprise receiving a request from the network entity for training data from at least one network function used for training the machine learning model associated with the analytics identifier and providing the training data to the network entity.

The method may be performed at an analytics data repository function or a data repository comprising the machine learning model and the training data.

The network entity may comprise an analytics network function or a radio access network node.

In an eighth aspect there is provided a method comprising providing a request from an analytics consumer for analytics information from a first machine learning model to a network entity, the first machine learning model associated with an analytics identifier, receiving first inference output from the first machine learning model from the network entity, determining feedback information based on the first inference output and providing the feedback information to the network entity.

When the feedback information is negative, the method may comprise providing a request to the network entity for further analytics information associated with the analytics identifier.

The network entity may comprise an analytics network function or a radio access node.

In a ninth aspect there is provided an apparatus comprising at least one processor, and at least one memory including computer program code, wherein the at least one memory and the computer program code are configured, with the at least one processor, to cause the apparatus at least to receive a request from an analytics consumer for analytics information from a first machine learning model, obtain the first machine learning model, obtain a second machine learning model, the second machine learning model being trained prior to the first machine learning model, the first machine learning model and the second machine learning model having the same analytics identifier, obtain a first inference output from the first machine learning model and a second inference output from the second machine learning model, determine, based on the first inference output and the second inference output that the first machine learning model has been attacked and provide an indication to a network entity that the first machine learning model has been attacked.

The apparatus may be caused to determine a concept drift between the first inference output and the second inference output and determine that the first machine learning model has been attacked based on the determined concept drift.

The apparatus may be caused to determine that the first machine learning model has been attacked based on a concept drift threshold value.

The apparatus may be caused to provide the first inference output to the analytics consumer, obtain feedback information based on the first inference output from the analytics consumer and determine that the first machine learning model has been attacked further based on the feedback information.

The apparatus may be caused to obtain first training data used for training the first machine learning model from at least one network function, obtain second training data used for training the second machine learning model from the at least one network function and determine a network function from the at least one network function where the first machine learning model was attacked based on the first training data and the second training data.

The apparatus may be caused to determine a data distribution drift based on the first training data and the second training data.

The apparatus may be caused to determine the network function from the plurality of network functions based on a data distribution drift threshold value.

The apparatus may be caused to provide an indication of the determined network function to the network entity.

The apparatus may be caused to exclude the determined network function when requesting data for subsequent training of the first machine learning model.

The network entity may comprise a network analytics function, an operations and management function or a user equipment.

In a tenth aspect there is provided an apparatus comprising at least one processor, and at least one memory including computer program code, wherein the at least one memory and the computer program code are configured, with the at least one processor, to cause the apparatus at least to receive a request from a network entity for a first machine learning model; provide the first machine learning model and receive an indication from the network entity that the first machine learning model has been attacked.

The apparatus may be caused to receive a request from the network entity for first training data from at least one network function used for training the first machine learning model, provide the first training data to the network entity and receive an indication from the network entity, based on the first training data, of a network function determined from the at least one network function where the first machine learning model was attacked.

The network entity may comprise an analytics network function, a radio access network node or an operations and management function.

In an eleventh aspect there is provided an apparatus comprising at least one processor, and at least one memory including computer program code, wherein the at least one memory and the computer program code are configured, with the at least one processor, to cause the apparatus at least to receive a request for receiving a request from a network entity for a machine learning model associated with an analytics identifier and provide the machine learning model associated with the analytics identifier to the network entity.

The apparatus may be caused to receive a request from the network entity for training data from at least one network function used for training the machine learning model associated with the analytics identifier and provide the training data to the network entity.

The apparatus may comprise an analytics data repository function or a data repository comprising the machine learning model and the training data.

The network entity may comprise an analytics network function or a radio access network node.

In a twelfth aspect there is provided an apparatus comprising at least one processor, and at least one memory including computer program code, wherein the at least one memory and the computer program code are configured, with the at least one processor, to cause the apparatus at least to provide a request from an analytics consumer for analytics information from a first machine learning model to a network entity, the first machine learning model associated with an analytics identifier, receive first inference output from the first machine learning model from the network entity, determine feedback information based on the first inference output and providing the feedback information to the network entity.

When the feedback information is negative, the apparatus may be caused to provide a request to the network entity for further analytics information associated with the analytics identifier.

The network entity may comprise an analytics network function or a radio access node.

In a thirteenth aspect there is provided a computer readable medium comprising instructions which, when executed by an apparatus, cause the apparatus to perform at least the following receiving a request from an analytics consumer for analytics information from a first machine learning model, obtaining the first machine learning model, obtaining a second machine learning model, the second machine learning model being trained prior to the first machine learning model, the first machine learning model and the second machine learning model having the same analytics identifier, obtaining a first inference output from the first machine learning model and a second inference output from the second machine learning model, determining, based on the first inference output and the second inference output that the first machine learning model has been attacked and providing an indication to a network entity that the first machine learning model has been attacked.

The apparatus may be caused to perform determining a concept drift between the first inference output and the second inference output and determining that the first machine learning model has been attacked based on the determined concept drift.

The apparatus may be caused to perform determining that the first machine learning model has been attacked based on a concept drift threshold value.

The apparatus may be caused to perform providing the first inference output to the analytics consumer, obtaining feedback information based on the first inference output from the analytics consumer and determining that the first machine learning model has been attacked further based on the feedback information.

The apparatus may be caused to perform obtaining first training data used for training the first machine learning model from at least one network function, obtaining second training data used for training the second machine learning model from the at least one network function and determining a network function from the at least one network function where the first machine learning model was attacked based on the first training data and the second training data.

The apparatus may be caused to perform determining a data distribution drift based on the first training data and the second training data.

The apparatus may be caused to perform determining the network function from the plurality of network functions based on a data distribution drift threshold value.

The apparatus may be caused to perform providing an indication of the determined network function to the network entity.

The apparatus may be caused to perform excluding the determined network function when requesting data for subsequent training of the first machine learning model.

The network entity may comprise a network analytics function, an operations and management function or a user equipment.

In a fourteenth aspect there is provided a computer readable medium comprising instructions which, when executed by an apparatus, cause the apparatus to perform at least the following receiving a request from a network entity for a first machine learning model, providing the first machine learning model and receiving an indication from the network entity that the first machine learning model has been attacked.

The apparatus may be caused to perform receiving a request from the network entity for first training data from at least one network function used for training the first machine learning model, providing the first training data to the network entity and receiving an indication from the network entity, based on the first training data, of a network function determined from the at least one network function where the first machine learning model was attacked.

The network entity may comprise an analytics network function, a radio access network node or an operations and management function.

In a fifteenth aspect there is provided a computer readable medium comprising instructions which, when executed by an apparatus, cause the apparatus to perform at least the following receiving a request for receiving a request from a network entity for a machine learning model associated with an analytics identifier and providing the machine learning model associated with the analytics identifier to the network entity.

The apparatus may be caused to perform receiving a request from the network entity for training data from at least one network function used for training the machine learning model associated with the analytics identifier and providing the training data to the network entity.

The apparatus may comprise an analytics data repository function or a data repository comprising the machine learning model and the training data.

The network entity may comprise an analytics network function or a radio access network node.

In a sixteenth aspect there is provided a computer readable medium comprising instructions which, when executed by an apparatus, cause the apparatus to perform at least the following providing a request from an analytics consumer for analytics information from a first machine learning model to a network entity, the first machine learning model associated with an analytics identifier, receiving first inference output from the first machine learning model from the network entity, determining feedback information based on the first inference output and providing the feedback information to the network entity.

When the feedback information is negative, the apparatus may be caused to perform providing a request to the network entity for further analytics information associated with the analytics identifier.

The network entity may comprise an analytics network function or a radio access node.

In a seventeenth aspect there is provided a non-transitory computer readable medium comprising program instructions for causing an apparatus to perform at least the method according to the third or fourth aspect.

In the above, many different embodiments have been described. It should be appreciated that further embodiments may be provided by the combination of any two or more of the embodiments described above.

### DESCRIPTION OF FIGURES

Embodiments will now be described, by way of example only, with reference to the accompanying Figures in which:

FIG. 1 shows a schematic diagram of an example 5GS communication system;

FIG. 2 shows a schematic diagram of an example mobile communication device;

FIG. 3 shows a schematic diagram of an example control apparatus;

FIG. 4 shows a flowchart of a method according to an example embodiment;

FIG. 4 shows a flowchart of a method according to an example embodiment;

FIG. 5 shows a flowchart of a method according to an example embodiment;

FIG. 6 shows a flowchart of a method according to an example embodiment;

FIG. 7 shows a signalling flow according to an example embodiment;

FIG. 8 shows a signalling flow according to an example embodiment.

FIG. 9 shows a signalling flow according to an example embodiment.

### DETAILED DESCRIPTION

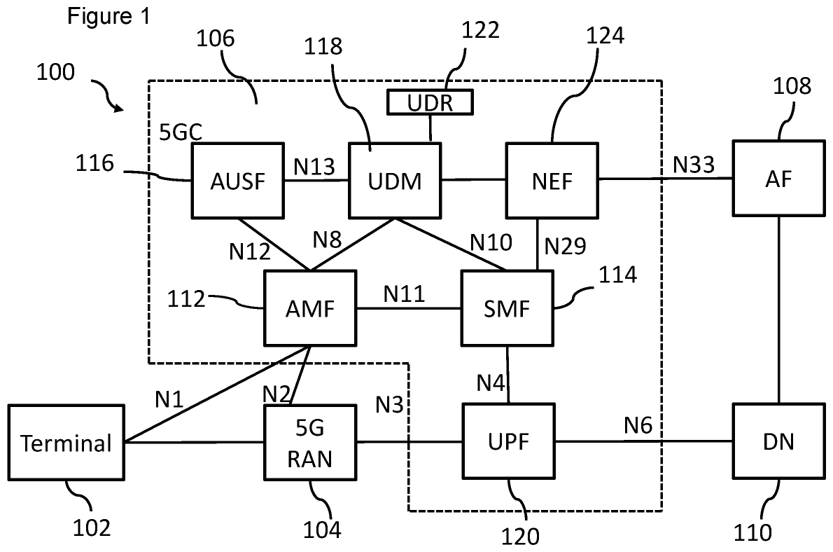

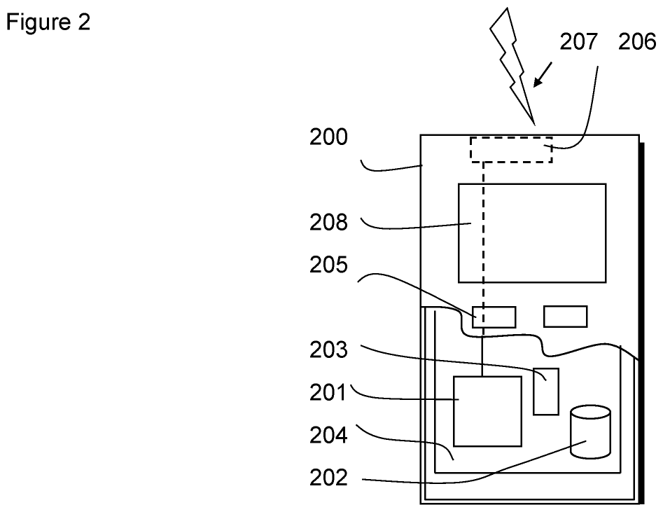

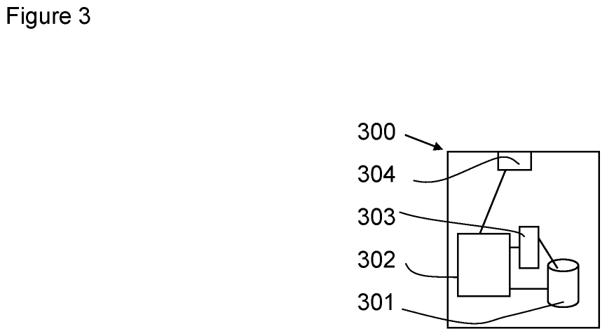

Before explaining in detail the examples, certain general principles of a wireless communication system and mobile communication devices are briefly explained with reference to FIG. 1, FIG. 2 and FIG. 3 to assist in understanding the technology underlying the described examples.

An example of a suitable communications system is the 5G or NR concept. Network architecture in NR may be similar to that of LTE-advanced. Base stations of NR systems may be known as next generation NodeBs (gNBs). Changes to the network architecture may depend on the need to support various radio technologies and finer Quality of Service (QOS) support, and some on-demand requirements for e.g. QoS levels to support Quality of Experience (QoE) for a user. Also network aware services and applications, and service and application aware networks may bring changes to the architecture. Those are related to Information Centric Network (ICN) and User-Centric Content Delivery Network (UC-CDN) approaches. NR may use Multiple Input-Multiple Output (MIMO) antennas, many more base stations or nodes than the LTE (a so-called small cell concept), including macro sites operating in co-operation with smaller stations and perhaps also employing a variety of radio technologies for better coverage and enhanced data rates.

Future networks may utilise network functions virtualization (NFV) which is a network architecture concept that proposes virtualizing network node functions into “building blocks” or entities that may be operationally connected or linked together to provide services. A virtualized network function (VNF) may comprise one or more virtual machines running computer program codes using standard or general type servers instead of customized hardware. Cloud computing or data storage may also be utilized. In radio communications this may mean node operations to be carried out, at least partly, in a server, host or node operationally coupled to a remote radio head. It is also possible that node operations will be distributed among a plurality of servers, nodes or hosts. It should also be understood that the distribution of labour between core network operations and base station operations may differ from that of the LTE or even be non-existent.

FIG. 1 shows a schematic representation of a 5G system (5GS) 100. The 5GS may comprise a user equipment (UE) 102 (which may also be referred to as a communication device or a terminal), a 5G radio access network (5GRAN) 104, a 5G core network (5GCN) 106, one or more internal or external application functions (AF) 108 and one or more data networks (DN) 110.

An example 5G core network (CN) comprises functional entities. The 5GCN 106 may comprise one or more Access and mobility Management Functions (AMF) 112, one or more session management functions (SMF) 114, an authentication server function (AUSF) 116, a Unified Data Management (UDM) 118, one or more user plane functions (UPF) 120, a Unified Data Repository (UDR) 122 and/or a Network Exposure Function (NEF) 124. The UPF is controlled by the SMF (Session Management Function) that receives policies from a PCF (Policy Control Function).

The CN is connected to a UE via the Radio Access Network (RAN). The 5GRAN may comprise one or more gNodeB (gNB) Distributed Unit (DU) functions connected to one or more gNodeB (gNB) Centralized Unit (CU) functions. The RAN may comprise one or more access nodes.

A User Plane Function (UPF) referred to as PDU Session Anchor (PSA) may be responsible for forwarding frames back and forth between the DN and the tunnels established over the 5G towards the UE(s) exchanging traffic with the DN.

A possible mobile communication device will now be described in more detail with reference to FIG. 2 showing a schematic, partially sectioned view of a communication device 200. Such a communication device is often referred to as user equipment (UE) or terminal. An appropriate mobile communication device may be provided by any device capable of sending and receiving radio signals. Non-limiting examples comprise a mobile station (MS) or mobile device such as a mobile phone or what is known as a ‘smart phone’, a computer provided with a wireless interface card or other wireless interface facility (e.g., USB dongle), personal data assistant (PDA) or a tablet provided with wireless communication capabilities, voice over IP (VoIP) phones, portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), smart devices, wireless customer-premises equipment (CPE), or any combinations of these or the like. A mobile communication device may provide, for example, communication of data for carrying communications such as voice, electronic mail (email), text message, multimedia and so on. Users may thus be offered and provided numerous services via their communication devices. Non-limiting examples of these services comprise two-way or multi-way calls, data communication or multimedia services or simply an access to a data communications network system, such as the Internet. Users may also be provided broadcast or multicast data. Non-limiting examples of the content comprise downloads, television and radio programs, videos, advertisements, various alerts, and other information.

A mobile device is typically provided with at least one data processing entity 201, at least one memory 202 and other possible components 203 for use in software and hardware aided execution of tasks it is designed to perform, including control of access to and communications with access systems and other communication devices. The data processing, storage and other relevant components can be provided on an appropriate circuit board and/or in chipsets. This feature is denoted by reference 204. The user may control the operation of the mobile device by means of a suitable user interface such as key pad 205, voice commands, touch sensitive screen or pad, combinations thereof or the like. A display 208, a speaker and a microphone can be also provided. Furthermore, a mobile communication device may comprise appropriate connectors (either wired or wireless) to other devices and/or for connecting external accessories, for example hands-free equipment, thereto.

The mobile device 200 may receive signals over an air or radio interface 207 via appropriate apparatus for receiving and may transmit signals via appropriate apparatus for transmitting radio signals. In FIG. 2 transceiver apparatus is designated schematically by block 206. The transceiver apparatus 206 may be provided for example by means of a radio part and associated antenna arrangement. The antenna arrangement may be arranged internally or externally to the mobile device.

FIG. 3 shows an example of a control apparatus 300 for a communication system, for example to be coupled to and/or for controlling a station of an access system, such as a RAN node, e.g. a base station, eNB or gNB, a relay node or a core network node such as an MME or Serving Gateway (S-GW) or Packet Data Network Gateway (P-GW), or a core network function such as AMF/SMF, or a server or host. The method may be implemented in a single control apparatus or across more than one control apparatus. The control apparatus may be integrated with or external to a node or module of a core network or RAN. In some embodiments, base stations comprise a separate control apparatus unit or module. In other embodiments, the control apparatus can be another network element such as a radio network controller or a spectrum controller. In some embodiments, each base station may have such a control apparatus as well as a control apparatus being provided in a radio network controller. The control apparatus 300 can be arranged to provide control on communications in the service area of the system. The control apparatus 300 comprises at least one memory 301, at least one data processing unit 302, 303 and an input/output interface 304. Via the interface the control apparatus can be coupled to a receiver and a transmitter of the base station. The receiver and/or the transmitter may be implemented as a radio front end or a remote radio head.

Currently proposals are being discussed with respect to Artificial Intelligence/Machine Learning (AI/ML) enhancements. One option is to enable cross domain machine learning, such that entities, e.g., UE(s), RAN, Management, 5G Core and AF(s), all participate in AI/ML operations. Cross domain AI/ML may lead to an increase in attack surface and thereby increase the possibilities of attacks at the AI/ML model (for instance data poisoning attacks) e.g., during the training and/or inference phase. Data poisoning attacks may, for example, involve a malicious entity, e.g., those entities mentioned above participating in AI/ML operations, injecting tampered data to influence the behavior of a trained AI/ML model or the training of an AI/ML model.

It would be useful in such attacks to detect that the system is attacked. It would also be useful to determine in which stage of the AI/ML model lifecycle the system is attacked and/or identify the attacker.

Data drift refers to the changing distribution of the data to which an AI/ML model is applied, while concept drift refers to a changing underlying goal or objective for the AI/ML model. The key difference between data drift and concept drift is that data drift refers to changes in the input data used for modeling, while concept drift refers to changes in the relationships between the input features and the target variable that a model is trying to predict. Both data drift and concept drift may lead to a decline in the performance of a machine learning model.

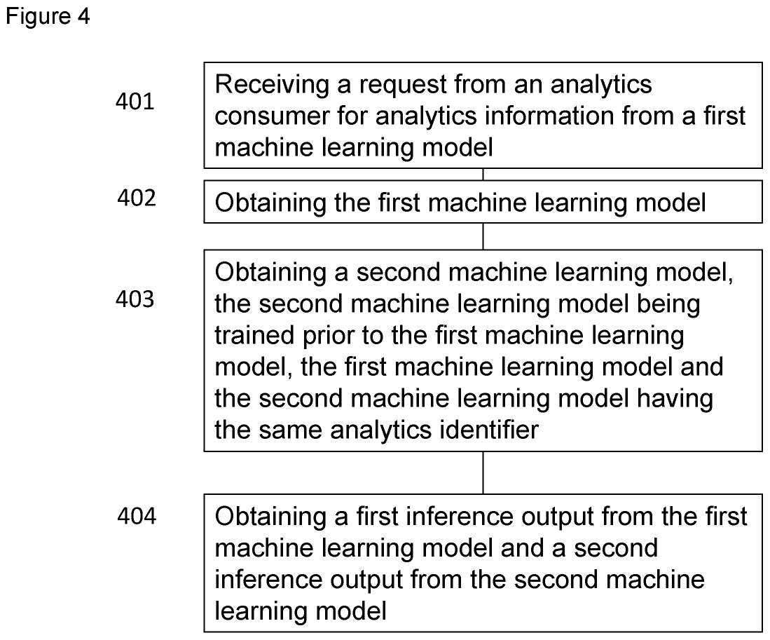

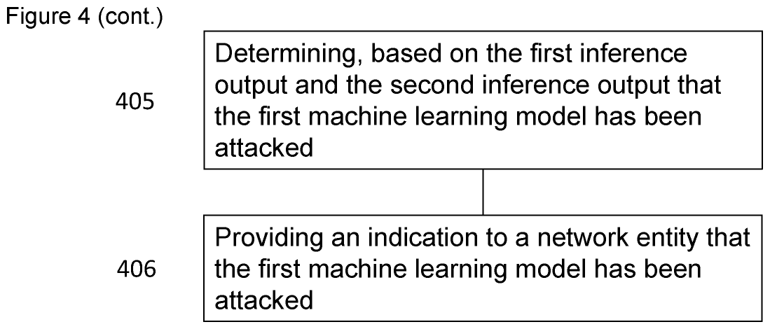

FIG. 4 shows a flowchart of a method according to an example embodiment. The method may be performed at a network analytics function (e.g., AnLF), RAN node or OAM.

In 401, the method comprises receiving a request from an analytics consumer for analytics information from a first machine learning model,

In 402, the method comprises obtaining the first machine learning model.

In 403, the method comprises obtaining a second machine learning model, the second machine learning model being trained prior to the first machine learning model, the first machine learning model and the second machine learning model having the same analytics identifier.

In 404, the method comprises obtaining a first inference output from the first machine learning model and a second inference output from the second machine learning model.

In 405, the method comprises determining, based on the first inference output and the second inference output that the first machine learning model has been attacked.

In 406, the method comprises providing an indication to a network entity that the first machine learning model has been attacked.

The method may comprise determining a concept drift between the first inference output and the second inference output and determining that the first machine learning model has been attacked based on the determined concept drift. Determining that the first machine learning model has been attacked may be based on a concept drift threshold value.

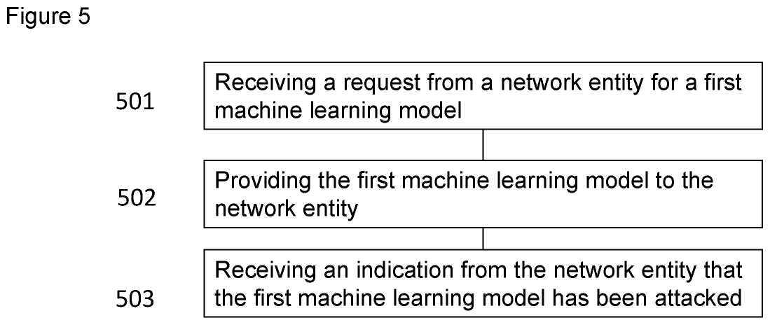

FIG. 5 shows a flowchart of a method according to an example embodiment. The method may be performed at a network analytics function (e.g., MTLF), 5GC NF (e.g., OAM) (e.g., in a cross domain model sharing concept) or a UE (e.g., in a UE model sharing concept).

In 501, the method comprises receiving a request from a network entity for a first machine learning model.

In 502, the method comprises providing the first machine learning model to the network entity.

In 503, the method comprises receiving an indication from the network entity that the first machine learning model has been attacked.

A method as described with reference to FIG. 5 may comprise receiving a request from the network entity for first training data from at least one network function used for training the first machine learning model, providing the first training data to the network entity and receiving an indication from the network entity, based on the first training data, of a network function determined from the at least one network function where the first machine learning model was attacked.

A method as described with reference to FIG. 5 may comprise training the first machine learning model using the first training data before providing the first machine learning model to the network entity.

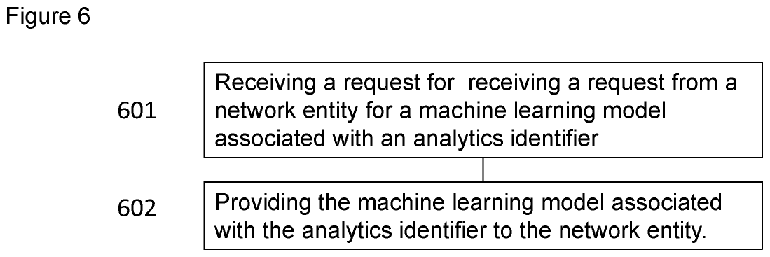

FIG. 6 shows a flowchart of a method according to an example embodiment. The method may be performed at an analytics data repository function or at any other suitable other data repository which stores AI/ML models and sample training data.

In 601, the method comprises receiving a request from a network entity for a machine learning model associated with an analytics identifier.

In 602, the method comprises providing the machine learning model associated with the analytics identifier to the network entity.

The method may comprise receiving a request from the network entity for training data from at least one network function used for training the machine learning model associated with the analytics identifier and providing the training data to the network entity.

A method as described with reference to FIG. 6 may comprise training the machine learning model using the training data before providing the machine learning model to the network entity. The machine learning model referred to in the method of FIG. 6 may comprise the second machine learning model referred to in the method of FIG. 4.

The method may comprise providing the first inference output to the analytics consumer, obtaining feedback information based on the first inference output from the analytics consumer and determining that the first machine learning model has been attacked further based on the feedback information.

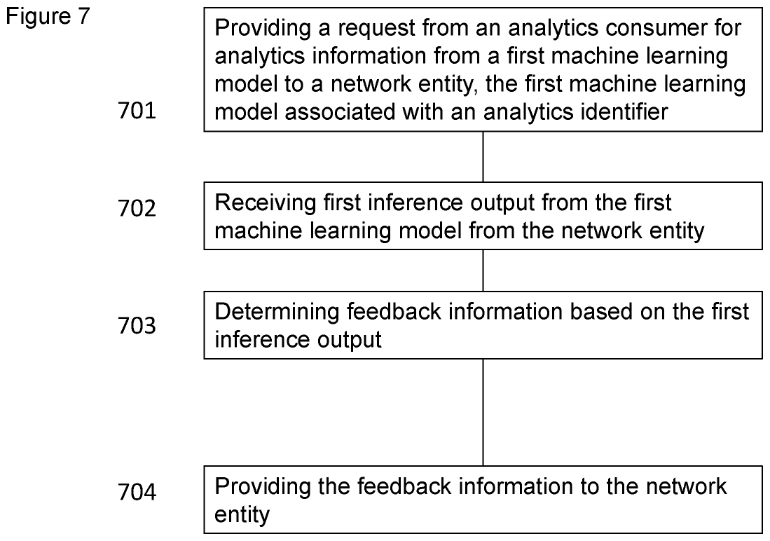

FIG. 7 shows an apparatus according to an example embodiment. The method may be performed at an analytics consumer. An analytics consumer may be a UE, OAM or other NF.

In 701, the method comprises providing a request from an analytics consumer for analytics information from a first machine learning model to a network entity, the first machine learning model associated with an analytics identifier.

In 702, the method comprises receiving first inference output from the first machine learning model from the network entity.

In 703, the method comprises determining feedback information based on the first inference output.

In 704, the method comprises providing the feedback information to the network entity.

When the feedback information is negative, the method as described with reference to FIG. 7 may comprise providing a request to the network entity for further analytics information associated with the analytics identifier.

Feedback information from the Analytics consumer may mean if the analytics requested helped the Analytics consumer to have a positive outcome in the process for which the analytics was requested (e.g., the feedback information is positive), or the received analytics resulted in negatively deteriorating its process performance (e.g., the feedback information is negative).

The method may provide a data poisoning attack detection and malicious entity identification mechanism. The method may detect if there is an attack or a genuine data distribution change being performed using the concept drift in inferences generated from the AI/ML models and/or the feedback mechanism from the analytics consumer which requested the data.

Further the identification of the attacker (in case of a positive attack) may be performed using training data analytics for the past and current data.

The method may comprise obtaining first training data used for training the first machine learning model from at least one NF, obtaining second training data used for training the second machine learning model from the at least one NF and determining a network function from the at least one network function where the first machine learning model was attacked based on the first training data and the second training data.

The method may comprise determining a data distribution drift based on the first training data and the second training data. Determining the network function from the plurality of network functions may be based on a data distribution drift threshold value.

Some example measures to determine data/concept drift may include Jenson-Shannon Divergence, Wasserstein's distance, Kullback-Leibler divergence, Population Stability Index, Euclidian distance, etc.

An example method may comprise providing an indication of the determined network function to the network entity. Alternatively, or in addition, an example method may comprise marking the determined NF as suspicious locally. An example method may comprise excluding the determined network function when requesting data for subsequent training of the first machine learning model

The method as described with reference to FIG. 4 may be performed at a ML model inference entity (e.g. NWDAF ANLF). The network entity may comprise a NWDAF such as a ML model training entity (e.g. NWDAF MTLF).

Alternatively, or in addition, in an example cross domain model sharing concept, a method as described with reference to FIG. 4 may be performed at a RAN node. The network entity may comprise the OAM/management domain.

Alternatively, or in addition, in an example the UE model sharing concept, the UE may train the model (i.e. act as the network entity). In this case, a method as described with reference to FIG. 4 may be performed at RAN/OAM.

The second machine learning model may be obtained from ADRF (SA2 architecture) or at any other suitable other data repository which stores AI/ML models and sample training data in the cross domain model sharing concept or UE model sharing concept.

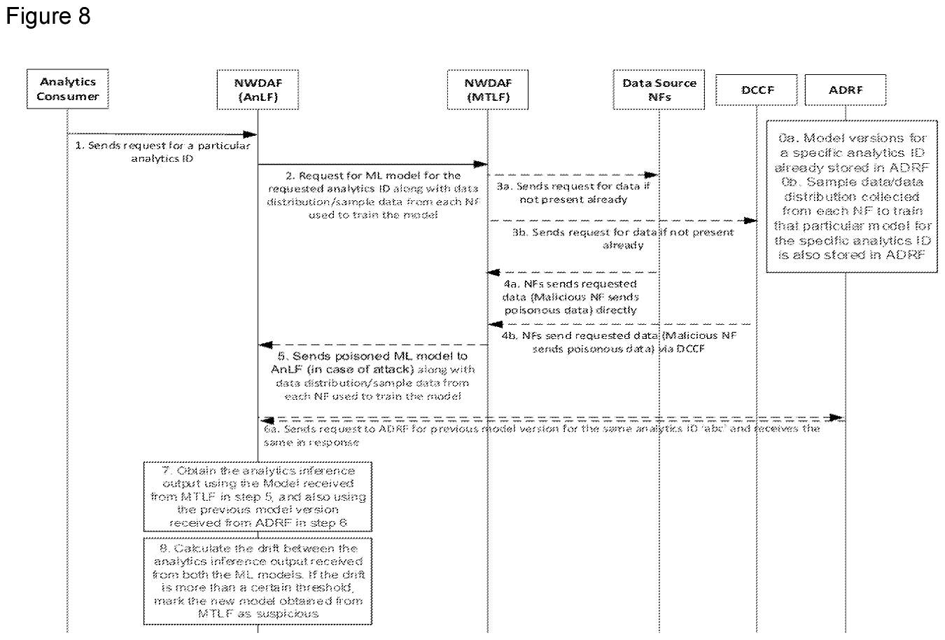

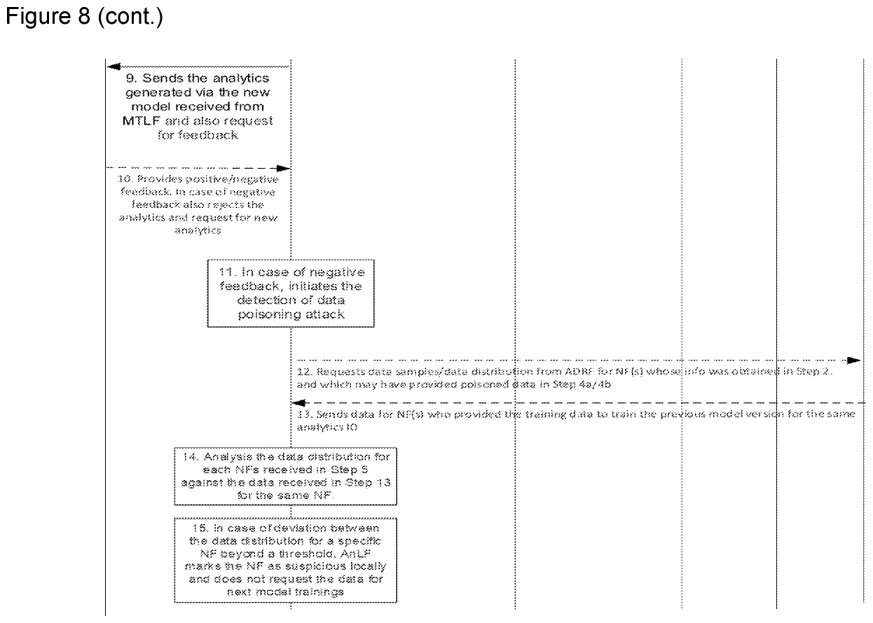

FIG. 8 shows a signalling diagram according to an example embodiment for NWDAF to NWDAF model sharing.

In this example embodiment, the ADRF contains the ML model versions corresponding (these are examples of the second machine learning model) to an analytics ID for which they were trained corresponding (these are examples of the second machine learning model). The ADRF also contains the sample data/data distribution for each NF which contributed to providing training data during the training of that particular ML model (this is an example of the second training data used for training the second machine learning model from the plurality of network functions).

In step 1, the Analytics Consumer (NFc) sends a request to NWDAF containing AnLF for a particular analytics ID. This is an example of receiving a request from an analytics consumer for analytics information from a machine learning model. In this example embodiment, a UE comprises the analytics consumer.

In step 2, AnLF requests a ML model corresponding to the requested analytics ID along with data distribution/sample data from each NF which will be used to train the ML model for the given analytics ID.

In steps 3, 4 and 5, NWDAF MTLF sends a request to other NFs for data collection either directly or via DCCF, and may receive malicious tempered data (in case a malicious NF wants to perform data poisoning attack). NWDAF MTLF trains the ML model (for e.g. Model ‘X’), and sends it to AnLF, along with the sample data/data distribution requested in Step 2 for each NF contributing to the training data.

Steps 2 to 4 are an example of obtaining the machine learning model and obtaining first training data used for training the first machine learning model from at least one network function.

In step 6, AnLF sends a request to ADRF to request for an already trained model version (if present) for the same analytics ID ‘abc’ and receives the same in response (i.e. ADRF sends the Model ‘Y’).

In step 7, AnLF obtains the analytics inference output using the Model ‘X’ received from MTLF in step 5, and also using the model version (Model ‘Y’) received from ADRF in step 6.

This is an example of obtaining a second machine learning model (e.g., Model ‘Y’), the second machine learning model being trained prior to the first machine learning model (e.g., Model ‘X’), the first machine learning model and the second machine learning model having the same analytics identifier.

In step 8, AnLF calculates the drift between the analytics inference output obtained from both the ML models (X and Y). If the drift is more than a certain threshold, mark the new model ‘X’ obtained from MTLF as suspicious.

Step 8 is an example of determining a concept drift between the first inference output and the second inference output and determining that the first machine learning model has been attacked based on the determined concept drift and a concept drift threshold value.

In step 9, AnLF sends the analytics generated via the new model received from MTLF to the Analytics Consumer and also request for its feedback.

In step 10, Analytics consumer provides positive/negative feedback. In case of negative feedback also rejects the analytics and request for new analytics to the AnLF.

Steps 9 and 10 are an example of providing the first inference output to the analytics consumer, obtaining feedback information based on the first inference output from the analytics consumer and determining that the first machine learning model has been attacked further based on the feedback information.

In step 11, AnLF initiates detection of data poisoning attack in case of negative feedback.

In step 12, AnLF sends a request to ADRF for historical data samples/data distribution for NF(s) whose info was obtained in Step 5 and which may have provided poisoned data in Step 4a/4b.

In step 13, ADRF sends data for NF(s) who provided the training data to train the previous model version for the same analytics ID. This is an example of obtaining second training data used for training the second machine learning model from the at least one network function.

In step 14, AnLF analysis the sample data/data distribution for each NFs received in Step 5 against the data received in Step 13 for the same NF.

In step 15, in case of deviation between the data distribution for a specific NF beyond a threshold, AnLF marks the NF as suspicious locally and does not request the data for next model trainings. AnLF can then notify MTLF about the suspicious NF and attack.

This is an example of determining a network function from at least one network functions where the first machine learning model was attacked based on the first training data and the second training data based data distribution drift between the first training data and the second training data and a data distribution drift threshold value.

In step 8, if the concept drift looks very abrupt and more likely due to an attack, the procedure may go directly can go to step 12 and proceed with the detection. This can help from unnecessary rollback after negative feedback. If step 8 is not giving a clear indication, the method may proceed with step 9.

In an alternate version after step 11, AnLF may indicate to MTLF to initiate detection of poisoning attack, such that steps 12, 13, 14, and 15 can be performed at MTLF and MTLF may then provide a response to AnLF in new step 16 about confirmation of the attack.

The method may be applied to any other domain or cross domain model sharing and analytics concept. In an example embodiment, when RAN receives the model from the OAM/management domain, analytics is performed at the RAN node, then a similar solution as described above would be applied to detect the issue.

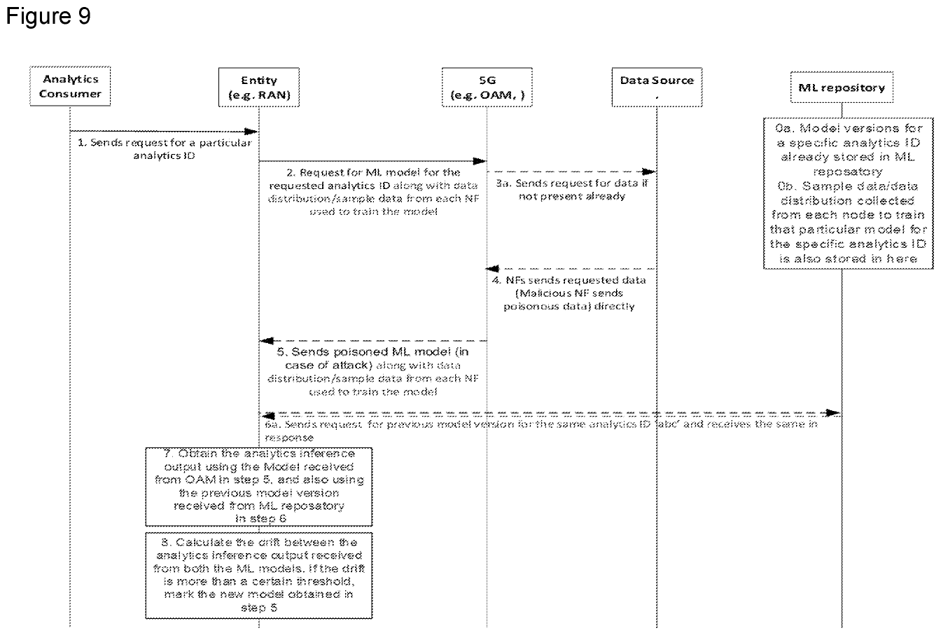

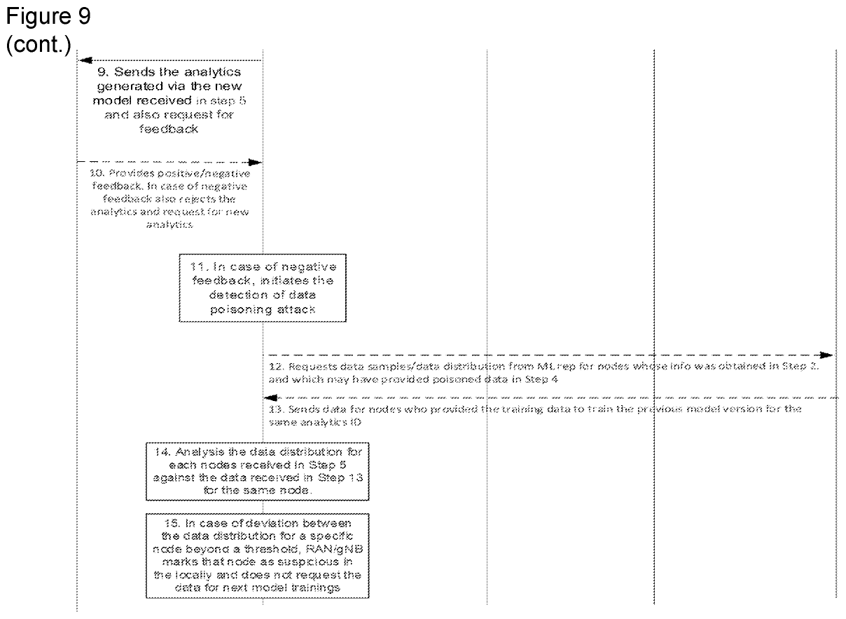

FIG. 9 shows an example call flow where analytics is performed at the RAN node. The steps of this method are as described with reference to FIG. 8 with the RAN node in place of the AnLF, the 5GC (e.g., OAM) in place of the MTLF and the ML repository in place of the ADRF.

In a UE model sharing concept, the UE can train the model and give it to RAN/OAM (example: beam forming use cases etc). UE uses local data to train the model. UE shall also push model and local data on the server/OAM (repository). Here when network detects an attack, then similar solution can be applied to detect the data poisoning attack.

An apparatus may comprise means for receiving a request from an analytics consumer for analytics information from a first machine learning model, obtaining the first machine learning model, obtaining a second machine learning model, the second machine learning model being trained prior to the first machine learning model, the first machine learning model and the second machine learning model having the same analytics identifier, obtaining a first inference output from the first machine learning model and a second inference output from the second machine learning model, determining, based on the first inference output and the second inference output that the first machine learning model has been attacked and providing an indication to a network entity that the first machine learning model has been attacked.

An apparatus may comprise means for receiving a request from a network entity for a first machine learning model, providing the first machine learning model and receiving an indication from the network entity that the first machine learning model has been attacked.

An apparatus may comprise means for providing a request from an analytics consumer for analytics information from a first machine learning model to a network entity, the first machine learning model associated with an analytics identifier, receiving first inference output from the first machine learning model from the network entity, determining feedback information based on the first inference output and providing the feedback information to the network entity.

An apparatus may comprise means for receiving a request for receiving a request from a network entity for a machine learning model associated with an analytics identifier and providing the machine learning model associated with the analytics identifier to the network entity.

An apparatus may comprise a network entity, such as a user equipment

An apparatus may comprise a network entity such as a user equipment (e.g., a mobile phone) or a network function (e.g., an analytics network function (such as AnLF or MTLF), a 5GC NF, OAM or repository function (e.g., ADRF)) or a RAN node, be the network entity or be comprised in the network entity or a chipset for performing at least some actions of/for the network entity.

It should be understood that the apparatuses may comprise or be coupled to other units or modules etc., such as radio parts or radio heads, used in or for transmission and/or reception. Although the apparatuses have been described as one entity, different modules and memory may be implemented in one or more physical or logical entities.

It is noted that whilst some embodiments have been described in relation to 5G networks, similar principles can be applied in relation to other networks and communication systems such as 6G networks or 5G-Advanced networks. Therefore, although certain embodiments were described above by way of example with reference to certain example architectures for wireless networks, technologies and standards, embodiments may be applied to any other suitable forms of communication systems than those illustrated and described herein.

It is also noted herein that while the above describes example embodiments, there are several variations and modifications which may be made to the disclosed solution without departing from the scope of the present invention.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

In general, the various embodiments may be implemented in hardware or special purpose circuitry, software, logic or any combination thereof. Some aspects of the disclosure may be implemented in hardware, while other aspects may be implemented in firmware or software which may be executed by a controller, microprocessor or other computing device, although the disclosure is not limited thereto. While various aspects of the disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
(i) a combination of analog and/or digital hardware circuit(s) with software/firmware and
(ii) any portions of hardware processor(s) with software (including digital signal processor(s)), software, and memory(ies) that work together to cause an apparatus, such as a mobile phone or server, to perform various functions) and
I hardware circuit(s) and or processor(s), such as a microprocessor(s) or a portion of a microprocessor(s), that requires software (e.g., firmware) for operation, but the software may not be present when it is not needed for operation.”

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The embodiments of this disclosure may be implemented by computer software executable by a data processor of the mobile device, such as in the processor entity, or by hardware, or by a combination of software and hardware. Computer software or program, also called program product, including software routines, applets and/or macros, may be stored in any apparatus-readable data storage medium and they comprise program instructions to perform particular tasks. A computer program product may comprise one or more computer-executable components which, when the program is run, are configured to carry out embodiments. The one or more computer-executable components may be at least one software code or portions of it.

Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD. The physical media is a non-transitory media.

The term “non-transitory,” as used herein, is a limitation of the medium itself (i.e., tangible, not a signal) as opposed to a limitation on data storage persistency (e.g., RAM vs. ROM).

The memory may be of any type suitable to the local technical environment and may be implemented using any suitable data storage technology, such as semiconductor based memory devices, magnetic memory devices and systems, optical memory devices and systems, fixed memory and removable memory. The data processors may be of any type suitable to the local technical environment, and may comprise one or more of general purpose computers, special purpose computers, microprocessors, digital signal processors (DSPs), application specific integrated circuits (ASIC), FPGA, gate level circuits and processors based on multi core processor architecture, as non-limiting examples.

Embodiments of the disclosure may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The scope of protection sought for various embodiments of the disclosure is set out by the independent claims. The embodiments and features, if any, described in this specification that do not fall under the scope of the independent claims are to be interpreted as examples useful for understanding various embodiments of the disclosure.

The foregoing description has provided by way of non-limiting examples a full and informative description of the exemplary embodiment of this disclosure. However, various modifications and adaptations may become apparent to those skilled in the relevant arts in view of the foregoing description, when read in conjunction with the accompanying drawings and the appended claims. However, all such and similar modifications of the teachings of this disclosure will still fall within the scope of this invention as defined in the appended claims. Indeed, there is a further embodiment comprising a combination of one or more embodiments with any of the other embodiments previously discussed.

1. An apparatus comprising:
at least one processor, and at least one memory including computer program code, wherein the at least one memory and the computer program code are configured, with the at least one processor, to cause the apparatus at least to perform:
receiving a request from an analytics consumer for analytics information from a first machine learning model;
obtaining the first machine learning model;
obtaining a second machine learning model, the second machine learning model being trained prior to the first machine learning model, the first machine learning model and the second machine learning model having the same analytics identifier;
obtaining a first inference output from the first machine learning model and a second inference output from the second machine learning model;
determining, based on the first inference output and the second inference output that the first machine learning model has been attacked; and
providing an indication to a network entity that the first machine learning model has been attacked.

2. The apparatus according to claim 1, wherein the at least one memory and the computer program code are configured, with the at least one processor, to cause the apparatus to perform determining a concept drift between the first inference output and the second inference output and determining that the first machine learning model has been attacked based on the determined concept drift.

3. The apparatus according to claim 2, wherein the at least one memory and the computer program code are configured, with the at least one processor, to cause the apparatus to perform determining that the first machine learning model has been attacked based on a concept drift threshold value.

4. The apparatus according to claim 1, wherein the at least one memory and the computer program code are configured, with the at least one processor, to cause the apparatus to perform providing the first inference output to the analytics consumer, obtaining feedback information based on the first inference output from the analytics consumer and determining that the first machine learning model has been attacked further based on the feedback information.

5. The apparatus according to claim 1, wherein the at least one memory and the computer program code are configured, with the at least one processor, to cause the apparatus to perform obtaining first training data used for training the first machine learning model from at least one network function, obtaining second training data used for training the second machine learning model from the at least one network function and determining a network function from the at least one network function where the first machine learning model was attacked based on the first training data and the second training data.

6. The apparatus according to claim 5, wherein the at least one memory and the computer program code are configured, with the at least one processor, to cause the apparatus to perform determining a data distribution drift based on the first training data and the second training data.

7. The apparatus according to claim 6, wherein the at least one memory and the computer program code are configured, with the at least one processor, to cause the apparatus to perform determining the network function from the plurality of network functions based on a data distribution drift threshold value.

8. The apparatus according to claim 5, wherein the at least one memory and the computer program code are configured, with the at least one processor, to cause the apparatus to perform providing an indication of the determined network function to the network entity.

9. The apparatus according to claim 1, wherein the at least one memory and the computer program code are configured, with the at least one processor, to cause the apparatus to perform excluding the determined network function when requesting data for subsequent training of the first machine learning model.

10. The apparatus according to claim 1, wherein the network entity comprises a network analytics function, an operations and management function or a user equipment.

11. An apparatus comprising:
at least one processor, and at least one memory including computer program code, wherein the at least one memory and the computer program code are configured, with the at least one processor, to cause the apparatus at least to perform:
receiving a request from a network entity for a first machine learning model;
providing the first machine learning model; and
receiving an indication from the network entity that the first machine learning model has been attacked.

12. The apparatus according to claim 11, comprising wherein the at least one memory and the computer program code are configured, with the at least one processor, to cause the apparatus to perform receiving a request from the network entity for first training data from at least one network function used for training the first machine learning model, providing the first training data to the network entity and receiving an indication from the network entity, based on the first training data, of a network function determined from the at least one network function where the first machine learning model was attacked.

13. The apparatus according to claim 11, wherein the network entity comprises an analytics network function, a radio access network node or an operations and management function.

14. An apparatus comprising:
at least one processor, and at least one memory including computer program code, wherein the at least one memory and the computer program code are configured, with the at least one processor, to cause the apparatus at least to perform:
receiving a request for receiving a request from a network entity for a machine learning model associated with an analytics identifier; and
providing the machine learning model associated with the analytics identifier to the network entity.

15. The apparatus according to claim 14, wherein the at least one memory and the computer program code are configured, with the at least one processor, to cause the apparatus to perform receiving a request from the network entity for training data from at least one network function used for training the machine learning model associated with the analytics identifier and providing the training data to the network entity.

16. The apparatus according to claim 14, wherein the apparatus comprises an analytics data repository function or a data repository comprising the machine learning model and the training data.

17. The apparatus according to claim 14, wherein the network entity comprises an analytics network function or a radio access network node.
